(19) United States
(12) Patent Application Publication
(10) Pub. No.: US 2014/0188568 A1
(43) Pub. Date: Jul. 3, 2014

(54) RECOMMENDING AN OPERATING CHARACTERISTIC OF A MERCHANT

(71) Applicant: Benjamin Margolin, San Mateo, CA (US)

(72) Inventor: Benjamin Margolin, San Mateo, CA (US)

(21) Appl. No.: 13/729,985

(22) Filed: Dec. 28, 2012

(51) Int. Cl. G06Q 10/06

(52) U.S. Cl. CPC G06Q 10/0637
USPC 705/7.36

(57) ABSTRACT

Recommending operating characteristics of merchants. Obtaining a location of mobile computing devices within areas referenced to a location of a merchant. The areas can be outside the range of a wireless local area network (WLAN) disposed within the location of the merchant. Estimating potential customer traffic in relation to the location of the merchant as a function of the obtained locations. Determining a recommended operating characteristic of the merchant as a function of the estimated potential customer traffic. Communicating the recommended operating characteristic to a computing device associated with the merchant.

### TECHNICAL FIELD

The technology disclosed herein pertains to recommending an operating characteristic of a merchant. More particularly, embodiments of the technology pertain to recommending such an operating characteristic based on traffic data in relation to the merchant location.

### BACKGROUND

Merchants may monitor customers within their stores using available technologies, such as door sensors, cameras, Bluetooth® wireless technology sensors, and WiFi® wireless technology sensors. Such technologies may, for example, count how many customers enter a merchant's store, how long such customers remain in the store, and how many customers make a purchase in the store. However, merchants typically do not have access to information about the quantity and other characteristics of customer traffic (both pedestrian and vehicle) that is in the neighborhood of the store but outside the range of these store sensors. Each person in such a neighboring area is a potential customer, and merchants could benefit from receiving information about these potential customers.

### SUMMARY

The technology includes computer-implemented methods, computer program products, and systems for recommending operating characteristics of merchants. In example embodiments, the location of each of a plurality of mobile computing devices within a plurality of areas referenced to a location of a merchant can be obtained. The areas can include areas outside the range of a wireless local area network (WLAN) disposed within the location of the merchant. Potential customer traffic in relation to the location of the merchant as a function of the obtained locations can be estimated. A recommended operating characteristic of the merchant as a function of the estimated potential customer traffic can be determined. The recommended operating characteristic to a computing device associated with the merchant can be communicated to a user of the system, e.g., a merchant.

In some embodiments, the area outside the range of the WLAN includes at least one road. In some embodiments, the recommended operating characteristic includes at least one of staffing level for the merchant, operating hours for the merchant, and an advertisement for the merchant made to at least one mobile computing device.

In some embodiments, an aggregate characteristic of a population of users associated with the located mobile computing devices can be determined. In such embodiments, the recommended operating characteristic can be determined as a function of the determined aggregate characteristic.

In some embodiments, a characteristic of a user associated with a located mobile computing device can be determined. In such embodiments, the recommended operating can be determined as a function of the determined characteristic of the user.

In some embodiments, a route associated with a located mobile computing device can be determined. In such embodiments, the recommended operating characteristic can be determined as a function of the determined route.

In some embodiments, a purchase associated with a located mobile computing device in the merchant location can be determined. In such embodiments, the recommended operating characteristic can be determined as a function of the purchase.

These and other aspects, objects, features, and advantages of the example embodiments will become apparent to those having ordinary skill in the art upon consideration of the following detailed description of illustrated example embodiments, which include the best mode of carrying out the invention as presently presented.

### BRIEF DESCRIPTION OF THE DRAWINGS

FIG. 1 is a diagram of an architecture for example embodiments of the technology disclosed herein.

FIG. 2 is a diagram of a merchant location and its surroundings, in accordance with certain example embodiments.

FIG. 3 is a diagram depicting methods for recommending an operating characteristic of a merchant, in accordance with certain example embodiments.

FIG. 4 is a diagram depicting methods for recommending an operating characteristic of a merchant, in accordance with certain example embodiments.

FIG. 5 is a diagram depicting methods for an operating characteristic of a merchant, in accordance with certain example embodiments.

FIG. 6 is a block diagram depicting a computing machine and a module, in accordance with certain example embodiments.

### DETAILED DESCRIPTION

### Overview

Embodiments of the technology disclosed herein include computer-implemented methods, computer program products, and systems for recommending operating characteristics of a merchant based at least in part on traffic data from areas neighboring a merchant location (not excluding traffic data from inside the range of the aforementioned sensors). An operating characteristic of the merchant can include, but is not limited to, staffing level, operating hours, stocking levels, and offers and advertisements based on potential customers in the neighborhood of the merchant.

### Example System Architectures

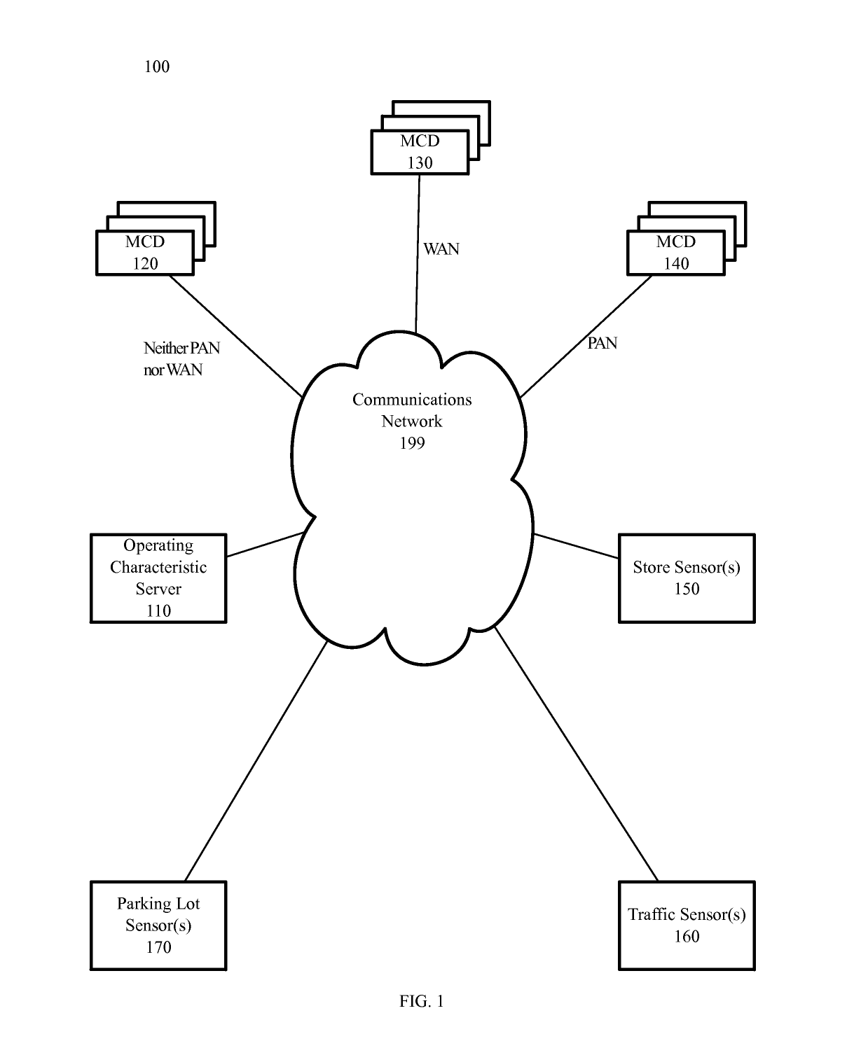

Turning now to the drawings, in which like numerals represent like (but not necessarily identical) elements throughout the figures, example embodiments are described in detail. FIG. 1 is a diagram of an architecture 100 for example embodiments of the technology disclosed herein. As depicted in FIG. 1, the architecture 100 includes network devices 110, 120, 130, 140, 150, 160, and 170, each of which may be configured to communicate with one another via communications network 199.

Network 199 includes one or more wired or wireless telecommunications means by which network devices may exchange data. For example, the network 199 may include one or more of a local area network (“LAN”), a wide area network (“WAN”), an intranet, an Internet, a storage area network (SAN), a personal area network (PAN), a metropolitan area network (MAN), a wireless local area network (WLAN), a virtual private network (VPN), a cellular or other mobile communication network, a Bluetooth connection, a near field communication (NFC) connection, any combination thereof, and any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device can include a communication module capable of transmitting and receiving data over the network 199. For example, each network device can include a server, a desktop computer, a laptop computer, a tablet computer, a television with one or more processors embedded therein and/or coupled thereto, a smart phone, a handheld computer, a personal digital assistant (“PDA”), or any other wired or wireless processor-driven device. In the example embodiment depicted in FIG. 1, the network devices 110, 150, and 170 may be operated by a merchant; each network device 120, 130, and 140 may be a mobile computing device operated by various users; and network device 160 may be operated by a traffic control entity, such as a local government.

A user may use an application, such as a web browser application or a native application, executing on a mobile computing device 120, 130, and 140 to view, download, upload, or otherwise access functionality and information via the network 199. The application may interact with web servers or other computing devices connected to the network 199, including operating characteristic server 110.

The network connections shown are example and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example each mobile computing device 120, 130, and 140 can be embodied as a mobile phone or handheld computer may not include all the components described above.

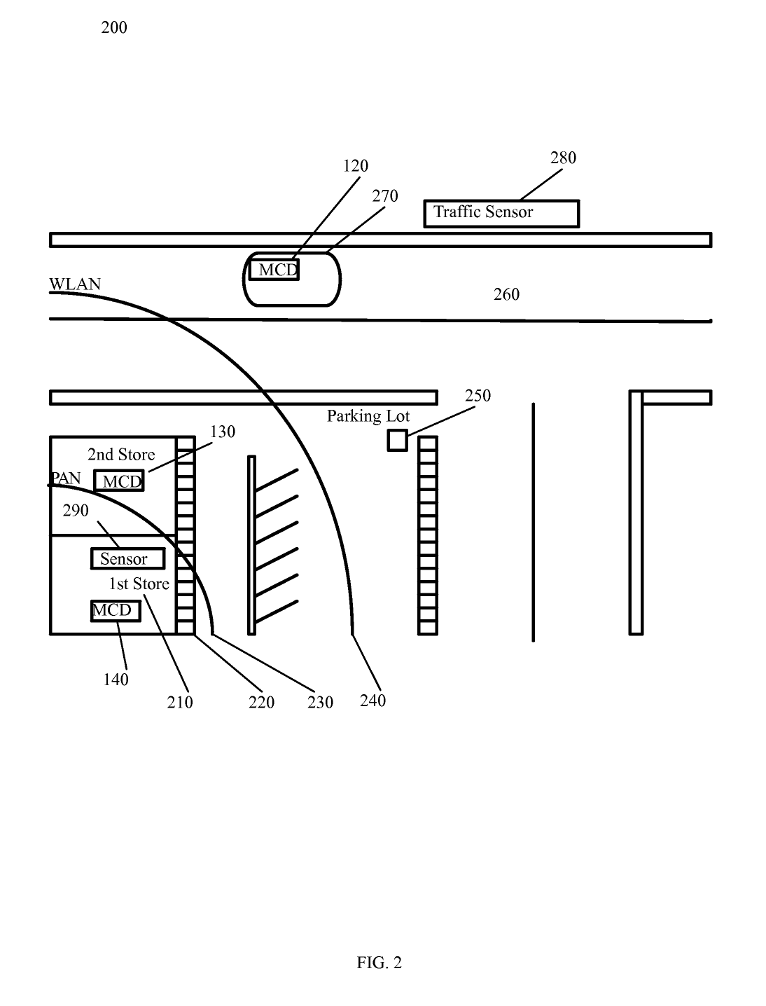

Referring to FIG. 2, in some embodiments of the technology, the location of mobile computing devices 120, 130, 140 of potential customers can be obtained within various areas referenced to a merchant's location 210. The areas references to the merchant's location can include, for example, an internal area of the merchant's store, an area adjacent to the merchant's store (such as front window, sidewalk 220), an area covered by a merchant's store-located personal area network (PAN) (such as Bluetooth wireless technology networks) 230, and an area covered by a merchant's store-located wireless area network (WLAN) (such as WiFi wireless technology networks) 240. The areas of the merchant also can include neighboring areas outside the range of PANs and WLANs (for example, on nearby roads) 260. Such locations can be obtained through sensors of various types such as a camera 250, including through use of geo-locating mobile computing devices such as mobile phones and tablet computers, e.g., 120 in vehicle 270, and traffic sensor 280 on nearby road 260. Traffic sensor 280 can be any type of in-road, overhead, or other traffic sensor.

Given the location of mobile computing devices 120, 130, 140 in various areas, e.g., 210, 220, 230, 240, and 260, in reference to the merchant location 210 (e.g., a physical store of the merchant), embodiments of the technology can estimate potential customer traffic in such areas. For example, given a first amount of mobile computing devices 120 located on a public road 260 near the merchant location, the total traffic on the road 260 can be estimated; given a second amount of mobile computing devices located on sidewalks 230 adjacent to the merchant location 210, pedestrian traffic adjacent to the store can be estimated; given a third amount of activations of a door sensor, pedestrian traffic into the merchant's store 210 can be estimated; and given point-of-sale device data, sales data can be obtained. Such collections of data, and correlations between such data, can be used to estimate both past and future potential customer traffic in relation to the merchant location 210, including what percentage of such traffic could successfully be converted to paying customers of the merchant at that location.

In certain embodiments of the technology, estimates of potential customer traffic in areas around the merchant location 210 can be used to determine a recommended operating characteristic of the merchant. For example, while the merchant is closed at a location (hence data is not being collected from in-store sensors 290), estimates of potential customer traffic can be estimated based on the location of mobile computing devices, e.g., 120, 130 outside the merchant location 210. The user device location may not be used in some embodiments unless the user has been given proper notice and/or provided consent for such use. In some embodiments, locations of user devices are anonymized and/or aggregated. Given traffic estimates meeting predetermined characteristics, for example, estimated volume of traffic and direction of traffic flow, the system can determine recommended operating hours for the merchant location 210. In some embodiments of the technology, heuristics can be used to relate certain traffic conditions to certain recommendations. For example, while a restaurant can plan to offer takeout specials during evening rush hour to take advantage of expected daily traffic patterns, embodiments of the present technology can recommend placing ads on the mobile computing devices, e.g., 120, determined to be located on a nearby road, e.g., 260, when traffic is moving at an unexpectedly slow pace outside expected rush hours, for example, in response to an accident during a non-rush period. This particular population of potential customers would not ordinarily be reached using conventional monitoring techniques.

### Example Processes

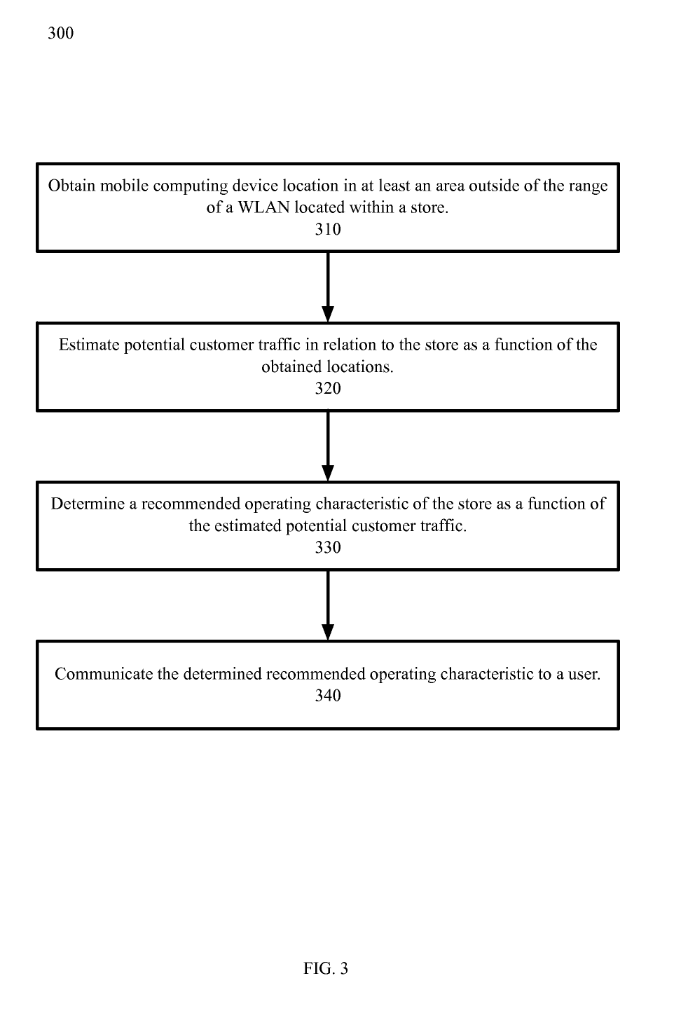

Referring to FIG. 3, and continuing to refer to the elements of FIG. 2 as examples, methods 300 for recommending an operating characteristic of a merchant are illustrated in accordance with certain example embodiments. Such embodiments can obtain the location of one or more mobile computing devices, such as device 120, located in an area outside of the merchant's location, e.g., first store 210—Block 310. For example, the technology can obtain the location of X mobile computing devices 120 on a road 260 near the merchant location, but outside the range of any PAN or WLAN at the merchant location. In this example, the MCD locations are obtained in the first half hour after the merchant location has closed for the day.

Potential customer traffic in relation to the store can then be estimated as a function of the obtained locations—Block 320. Continuing with the previous example, assume that the model(s) of the MCDs 120 for which the technology has obtained location on the road 260 are known to make up 20% of the MCD market, that typically a vehicle contains 1.4 MCDs, and that a typical person carrying an MCD carries a single MCD. Under such conditions, the technology can estimate that 5× persons in 5×/1.4 vehicles are on that particular highway.

One or more operating characteristics of the merchant location can then be determined as a function of the estimated potential customer traffic—Block 330. Continuing with the previous example, embodiments of the technology can be configured to recommend an extension of operating hours when a half hour period contiguous to the opening or closing hour of the merchant location estimates traffic on the highway over a predetermined threshold, e.g., 2× vehicles. In the present example, 5×/1.4>2×, and an extension of operating hours (an operating characteristic of the merchant location), can be recommended.

The determined recommended operating characteristic can then be communicated, e.g., via display, to a user; for example to a merchant user of a system of the technology—Block 340.

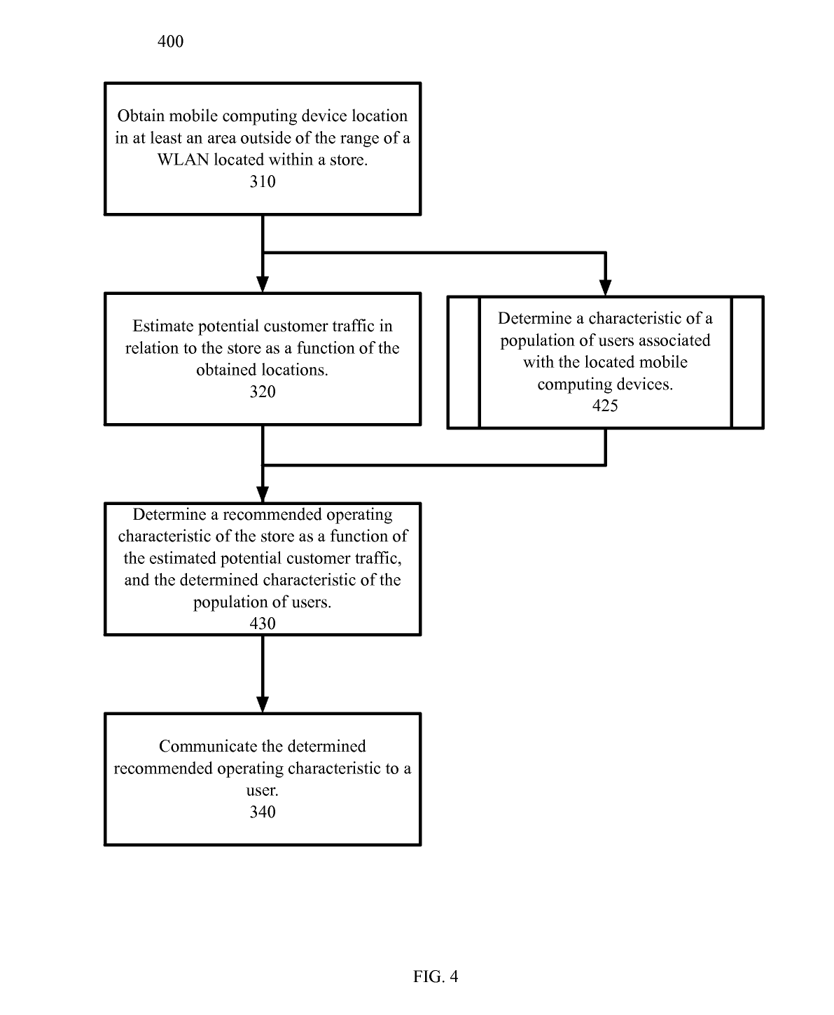

Embodiments of the technology can determine a characteristic of a population of users associated with one or more mobile computing devices, e.g., 120, 130, 140. Referring to FIG. 4, and continuing to refer to elements of earlier figures for context, methods 400 for recommending coupon features, creating coupons, and updating effectiveness data, in accordance with certain example embodiments are illustrated. In such methods, after obtaining the location of one or more mobile computing devices in an area outside the range of a WLAN of the merchant location (Block 310), and concurrent with estimating potential customer traffic in relation to the merchant location as a function of the obtained locations (Block 320), a characteristic of a population of users associated with those mobile computing devices can be determined. Both the estimated potential customer traffic and the determined characteristic of the population of mobile computing device users can be used to determine a recommended operating characteristic of the merchant location.

In the context of the previous example, consider that the merchant carries products or offers services that are primarily of interest to consumers under the age of 40; and consider that the model for recommending an extension of operating hours uses 40 as a maximum average age for recommending extension of operating hours. If the technology determines that the average age of consumers associated with the X MCDs located on the road 260 is 48, then the technology will not determine a recommendation to extend operating hours, even if the volume of traffic exceed 2× vehicles.

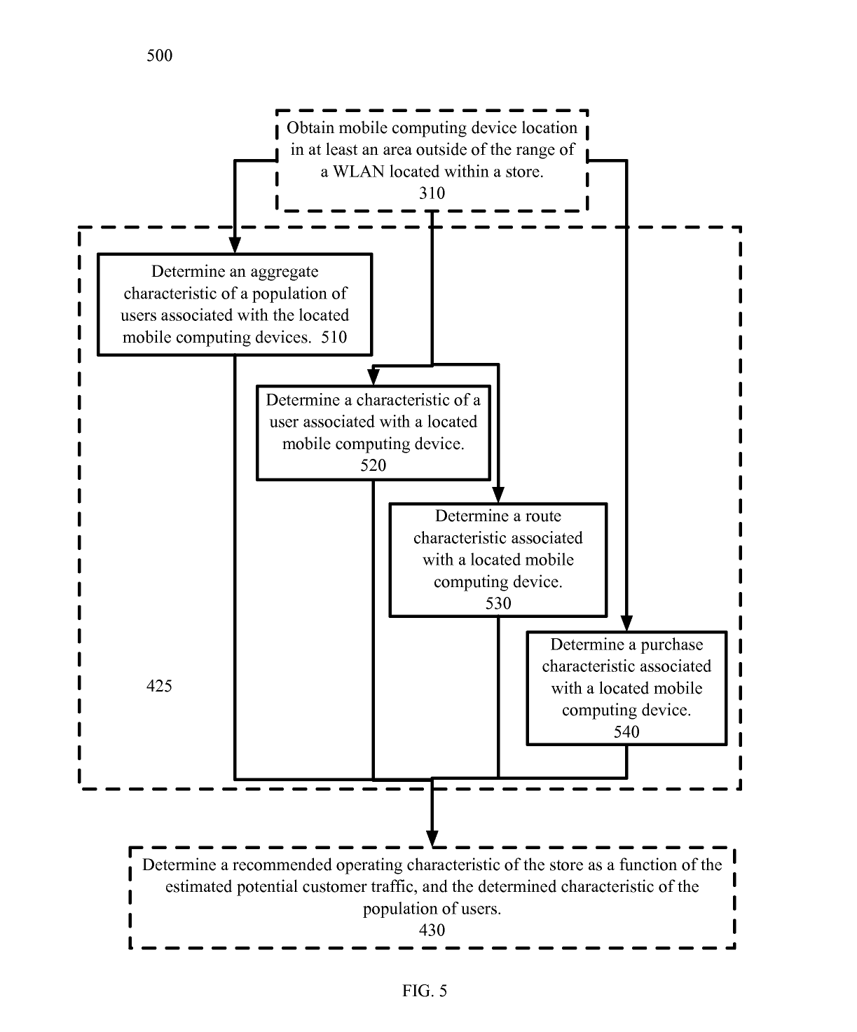

Referring to FIG. 5, and continuing to refer to FIG. 3 and FIG. 4 for context, methods 500 for determining a characteristic of a population of users associated with located mobile computing devices are illustrated. In such methods, after obtaining the location of at least one mobile computing device in a location outside the range of a WLAN associated with a merchant location (Block 310), an aggregate characteristic of a population of users associated with located mobile computing devices can be determined—Block 510. An operating characteristic of the merchant can be determined as a function of the aggregate characteristic (Block 430). The preceding paragraph presents an example of such a situation.

Some embodiments of the technology can determine a characteristic of a user associated with one of the mobile computing devices—Block 520. Operating characteristics of the merchant can be determined as a function of the determined characteristic of the user associated with the mobile computing device (Block 430). For example, a user associated with a particular located MCD may be known to be interested in the products offered at the merchant location. In such a case, an advertisement can be pushed, e.g., via e-mail or via short message service (SMS) notifying the user that they are in the vicinity of the merchant location, and offering a discount on purchases made within the next hour.

Some embodiments of the technology can determine a characteristic of a route, including a route destination associated with at least one of the mobile computing devices—Block 530. Operating characteristics of the merchant can be determined as a function of the determined route characteristic (Block 430). Embodiments of the technology can determine purchases at the merchant location associated with a first group of the located mobile computing devices—Block 540. Operating characteristics of the merchant can be determined as a function of the determined purchases (Block 430).

As an example, consider a restaurant in a downtown pedestrian plaza, having parking lots behind the plaza and out of reach of in-store sensors, PANs, and WLANs. A cinema complex is located on the far side of the parking lots. In certain embodiments, the technology can identify route information of navigation-capable mobile computing devices indicating the cinema complex as a destination. The technology can recommend pushing ads to such devices for “after the show” specials. Subsequently, the technology can identify route information of navigation-capable mobile computing devices indicating the cinema complex as a starting point. The technology can recommend pushing ads to such device for “now that the show is over” specials. In store sensors, PANs, and WLANs can then determine traffic entering the plaza, entering the restaurant, and making a purchase at the restaurant. Data on each type of traffic during “after the show” and “now that the show is over” ad campaigns can be compared to similar data in the absence of such campaigns to estimate the effectiveness of such a campaign.

In some embodiments of the technology, the data for one merchant can be comparing with the data for other merchants, for example, merchants in the same business category, in the same geographic area, or in the same business category and same area. In the preceding example, traffic data collected on the restaurant can be compared to traffic data for other restaurants in the plaza, non-restaurant businesses in the plaza, and other restaurants (same category) between the plaza and a popular destination, for example, a sports arena several miles away. Comparisons can be between the business-in-question and aggregate characteristics of similar businesses (for example, same plaza, same category) to avoid sharing specific information about an individual compared business.

Traffic can be classified by: type, such as vehicle, pedestrian; by area (as described above, or using subsets of the areas described above); and by action (for example, purchasing as determined by a mobile computing device or point-of-sale device). Traffic type can be inferred, for example, by characteristics such as location and velocity). These classifications can be used as factors in the determination of merchant operating characteristics. Traffic data can be collected as location data, for example, via geo-locating mobile computing devices (effectively a sample of all electronically enabled traffic on the road and sidewalk). Geo-locations moving over time beyond a threshold can be characterized as “on the road.” Road geo-location can be characterized as on the road regardless of speed. Traffic data can include destination info (from the route in a GPS or mobile phone). Traffic data can include point-of-sale data. Traffic data can be combined with sales data and correlations/trends can be analyzed (for example, on Sunday morning, a supermarket converts a higher percentage than average of traffic on an adjoining road to business). The traffic estimate can be by volume/time, and by type (if information such as age, income, destination, product preferences about the traffic can be determined/inferred by associating a user with the device carried in the traffic). Example uses of this information include resource scheduling, testing responses to offers, determining offers to extend, and determining ads to place. In some embodiments, this data can be combined with online “traffic” data (for example, web searches, web site visits) to further refine the determined operating characteristic of the merchant.

### Other Example Embodiments

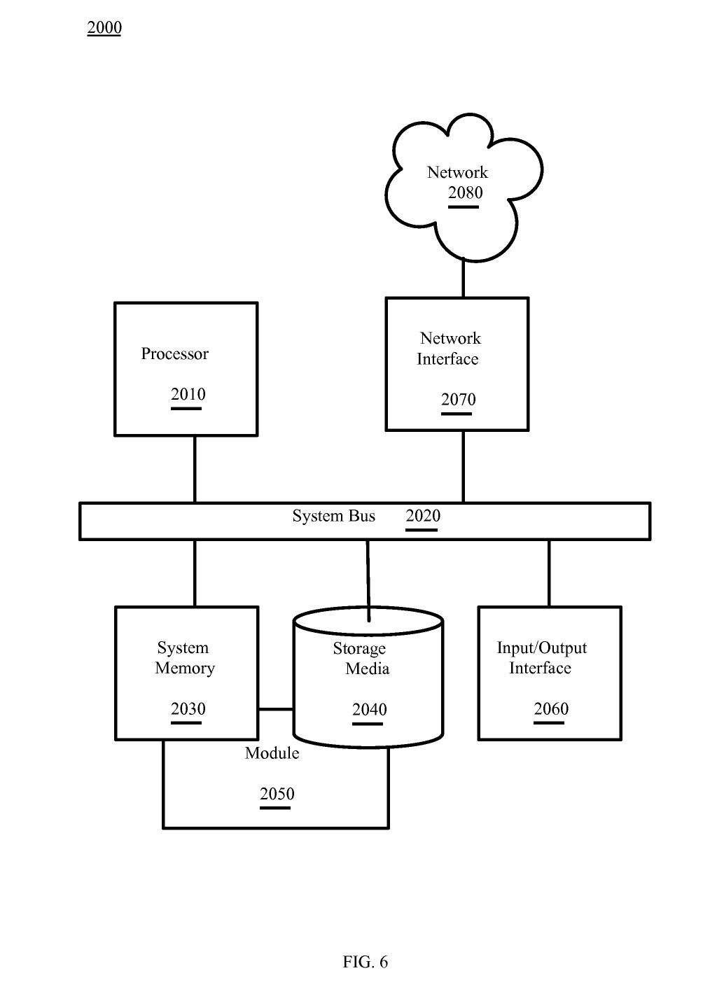

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the technology discussed here collects personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the technology described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

We claim:

1. A computer-implemented method for recommending operating characteristics of merchants, the method comprising:
obtaining, using one or more computing devices, a location of each of a plurality of mobile computing devices within a plurality of areas referenced to a location of a merchant, the areas comprising at least one area outside the range of a wireless local area network (WLAN) disposed within the location of the merchant;
estimating, using the one or more computing devices, potential customer traffic in relation to the location of the merchant as a function of the obtained locations;
determining, using the one or more computing devices, a recommended operating characteristic of the merchant as a function of the estimated potential customer traffic; and
communicating, using the one or more computing devices, the recommended operating characteristic to a computing device associated with the merchant.

2. The computer-implemented method of claim 1, wherein the at least one area outside the range of the WLAN comprises at least one road.

3. The computer-implemented method of claim 1, wherein the recommended operating characteristic includes at least one of staffing level for the merchant, operating hours for the merchant, and an advertisement for the merchant made to at least one mobile computing device.

4. The computer-implemented method of claim 1, further comprising determining, using the one or more computing devices, an aggregate characteristic of a population of users associated with the located mobile computing devices, wherein determining the recommended operating characteristic comprises determining the recommended operating characteristic as a function of the determined aggregate characteristic.

5. The computer-implemented method of claim 1, further comprising determining, using the one or more computing devices, a characteristic of a user associated with a located mobile computing devices, wherein determining the recommended operating characteristic comprises determining the recommended operating characteristic as a function of the determined characteristic of the user.

6. The computer-implemented method of claim 1, further comprising determining, using the one or more computing devices, a route associated with a located mobile computing device, wherein determining the recommended operating characteristic comprises determining the recommended operating characteristic as a function of the determined route.

7. The computer-implemented method of claim 1, further comprising determining, using the one or more computing devices, at least one purchase in the merchant associated with a located mobile computing device, wherein determining the recommended operating characteristic comprises determining the recommended operating characteristic as a function of the determined at least one purchase.

8. A computer program product for recommending operating characteristics of merchants, the method comprising:
a non-transitory computer-executable storage device having computer-readable program instructions embodied thereon that when executed by a computer perform a method for recommending operating characteristics of merchants comprising:
obtaining, using one or more computing devices, a location of each of a plurality of mobile computing devices within a plurality of areas referenced to a location of a merchant, the areas comprising at least one area outside the range of a wireless local area network (WLAN) disposed within the location of the merchant;
estimating, using the one or more computing devices, potential customer traffic in relation to the location of the merchant as a function of the obtained locations;
determining, using the one or more computing devices, a recommended operating characteristic of the merchant as a function of the estimated potential customer traffic; and
communicating, using the one or more computing devices, the recommended operating characteristic to a computing device associated with the merchant.

9. The computer program product of claim 8, wherein the at least one area outside the range of the WLAN comprises at least one road.

10. The computer program product of claim 8, wherein the recommended operating characteristic includes at least one of staffing level for the merchant, operating hours for the merchant, and an advertisement for the merchant made to at least one mobile computing device.

11. The computer program product of claim 8, further comprising determining, using the one or more computing devices, an aggregate characteristic of a population of users associated with the located mobile computing devices, wherein determining the recommended operating characteristic comprises determining the recommended operating characteristic as a function of the determined aggregate characteristic.

12. The computer program product of claim 8, further comprising determining, using the one or more computing devices, a characteristic of a user associated with a located mobile computing devices, wherein determining the recommended operating characteristic comprises determining the recommended operating characteristic as a function of the determined characteristic of the user.

13. The computer program product of claim 8, further comprising determining, using the one or more computing devices, a route associated with a located mobile computing device, wherein determining the recommended operating characteristic comprises determining the recommended operating characteristic as a function of the determined route.

14. The computer program product of claim 8, further comprising determining, using the one or more computing devices, at least one purchase in the merchant associated with a located mobile computing device, wherein determining the recommended operating characteristic comprises determining the recommended operating characteristic as a function of the determined at least one purchase.

15. A system to operate a coupon program, the system comprising:
a storage resource;
a network module; and
a processor communicatively coupled to the storage resource and the network module, wherein the processor executes computer-readable instructions that are stored in the storage resource and that cause the system to:
obtaining, using one or more computing devices, a location of each of a plurality of mobile computing devices within a plurality of areas referenced to a location of a merchant, the areas comprising at least one area outside the range of a wireless local area network (WLAN) disposed within the location of the merchant;
estimating, using the one or more computing devices, potential customer traffic in relation to the location of the merchant as a function of the obtained locations;
determining, using the one or more computing devices, a recommended operating characteristic of the merchant as a function of the estimated potential customer traffic; and
communicating, using the one or more computing devices, the recommended operating characteristic to a computing device associated with the merchant.

16. The system of claim 15, wherein the at least one area outside the range of the WLAN comprises at least one road.

17. The system of claim 15, wherein the recommended operating characteristic includes at least one of staffing level for the merchant, operating hours for the merchant, and an advertisement for the merchant made to at least one mobile computing device.

18. The system of claim 15, further comprising determining, using the one or more computing devices, an aggregate characteristic of a population of users associated with the located mobile computing devices, wherein determining the recommended operating characteristic comprises determining the recommended operating characteristic as a function of the determined aggregate characteristic.

19. The system of claim 15, further comprising determining, using the one or more computing devices, a characteristic of a user associated with a located mobile computing devices, wherein determining the recommended operating characteristic comprises determining the recommended operating characteristic as a function of the determined characteristic of the user.

20. The system of claim 15, further comprising determining, using the one or more computing devices, a route associated with a located mobile computing device, wherein determining the recommended operating characteristic comprises determining the recommended operating characteristic as a function of the determined route.

21. The system of claim 15, further comprising determining, using the one or more computing devices, at least one purchase in the merchant associated with a located mobile computing device, wherein determining the recommended operating characteristic comprises determining the recommended operating characteristic as a function of the determined at least one purchase.
